(19) United States
(12) Patent Application Publication
(10) Pub. No.: US 2017/0257719 A1
(43) Pub. Date: Sep. 7, 2017

(54) Method for producing an acoustical damping unit for an electro-acoustical transducer, acoustical damping unit and electro-acoustical transducer

(71) Applicant: Sennheiser electronic GmbH & Co. KG, Wedemark (DE)

(72) Inventor: Stefan Marten, Wedemark (DE)

(21) Appl. No.: 15/446,752

(22) Filed: Mar. 1, 2017

(30) Foreign Application Priority Data
Mar. 1, 2016 (DE) 102016103622.6

(51) Int. Cl. H04R 31/00; H04R 1/28; B29C 67/00; B33Y 10/00; B33Y 80/00

(52) U.S. Cl. CPC H04R 31/00; B33Y 10/00; B33Y 80/00; B29C 67/0055; H04R 1/2876; B29L 2031/38

(57) ABSTRACT

In a method for producing an acoustical damping unit, a plurality of bodies, e.g. plastic balls, of predefined sizes are produced and brought together in a desired shape by a 3D printing process. The bodies are arranged such that air can flow through gaps between them, wherein the air can flow through the complete acoustical damping unit. The gaps are interconnected so that the acoustical damping unit is open-pored. An acoustical damping unit in the form of a 3-dimensional body with a desired acoustical damping can be produced by adjusting the size of the bodies, the temperature of the plastic and the speed of application of the plastic bodies.

The present invention relates to a method for producing an acoustical damping unit, to an acoustical damping unit and an electro-acoustical transducer.

Electro-acoustical transducers are used for example in headphones, loudspeakers or microphones. Electro-acoustical transducers typically comprise a diaphragm system, which partially needs to be subjected to acoustical damping. Electro-acoustical damping units are known for that purpose.

DE 197 37 461 C2 discloses an acoustical transducer with a diaphragm system and a damping unit made of a sintered material. The damping unit is used for damping the diaphragm system. The damping unit comprises plastic like e.g. PE. The damping unit can have a 3-dimensional structure. By using a sintered material as the acoustical damping unit, better coupling between the diaphragm and the damping unit can be achieved, because the volume of the damping medium in the damping unit is relatively large compared to the volume between the damping material and the diaphragm system.

To be able to produce an electro-acoustical transducer of high quality it is important amongst other things to be able to produce the electro-acoustical transducer with a high degree of reproducibility. Therefore it is also necessary to achieve high reproducibility of the acoustical damping unit.

It is therefore an object of the present invention to provide a method for producing an electro-acoustical transducer, as well as an electro-acoustical transducer unit that can be produced with higher reproducibility. It is a further object of the present invention to provide a method for producing an acoustical damping unit, and an acoustical damping unit that can be produced with higher reproducibility.

That object is attained by a method for producing an acoustical damping unit according to claim 1 and an acoustical damping unit according to claim 8, as well as an electro-acoustical transducer according to claim 13. Claims 14 and 15 relate to a headphone and a microphone respectively with at least one acoustical damping unit according to the invention.

Thus, a method for producing an acoustical damping unit is provided. In that case an acoustical damping unit is produced by a 3D printing process. The correspondingly produced damping unit is placed in an electro-acoustical transducer. The acoustical damping unit can consist of a plurality of bodies, or particles, which are brought together in a 3D printing process. There can be gaps, e.g. holes or openings, between the bodies. The bodies are arranged such that air can flow through the gaps between the bodies. Since the gaps are interconnected air can flow through the complete acoustical damping unit. In other words, the damping unit is open-pored.

The acoustical characteristics of the damping unit can be controlled by adjusting the size of the bodies and the size of the gaps or holes between the bodies and by adjusting the number of layers

According to an aspect of the present invention the application of plastic particles made of a thermoplastic material and produced by an extruder nozzle takes place on an XY table. The application of the plastic particles is repeated until a desired 3-dimensional body is obtained.

According to a further aspect of the present invention a 3-dimensional body with a desired acoustical damping characteristic and of a desired shape can be produced by adjusting the size of the bodies, the temperature of the plastic and the application speed of the plastic balls.

The invention also relates to an acoustical damping unit for an electro-acoustical transducer that comprises a plurality of interconnected plastic particles that were produced and interconnected by 3D printing. During the 3D printing operation each plastic particle is at least partly fused or otherwise connected, e.g. by glue, to neighboring plastic particles, wherein gaps remain between the plastic particles. Those are also interconnected so that air can pass through the acoustical damping unit.

The invention also relates to an electro-acoustical transducer with at least one acoustical damping unit, wherein the acoustical damping unit represents a 3-dimensional body having a plurality of plastic particles which are made of a thermoplastic material and which are at least partly fused to neighboring plastic particles, leaving open gaps between them.

The invention relates to the concept of producing acoustical damping units or elements, in particular for electro-acoustical transducers, by injection molding and stereolithography. In other words, electro-acoustical damping elements are produced by 3D printing. An advantage of 3D printing as compared to other known methods for producing open-pored damping materials is the fact that the size and shape of the utilized bodies (such as e.g. plastic balls), the degree of fusing thereof and thus also the size of the cavities or gaps between them can be controlled very exactly. In that way the acoustical characteristics of the damping material can also be predicted and adjusted very exactly. Thus damping units with specific desired characteristics can be reproduced, while conventional production of damping units is largely a random process.

Thus there is provided a method for producing an acoustical damping unit for electro-acoustical transducers, wherein the acoustical damping unit is produced by 3D printing.

In that respect small plastic balls can be produced from a thermoplastic material by an extruder nozzle. These plastic balls can be positioned in layers on an XY table on the basis of CAD data. At their edges the plastic balls can be fused to the neighboring balls, so that mesh-like and connected surfaces can result. By shifting the XY table in the Z direction a subsequent layer of balls can be applied, which are then again fused to neighboring balls, resulting in a 3-dimensional body. In that way an acoustical damping unit can be made from a plurality of layers of thermoplastic balls that are produced by an extruder nozzle.

The invention also relates to the use of a 3D printer for producing acoustical damping units for electro-acoustical transducers.

The structure of an acoustical damping unit produced accordingly can be varied by the size of the plastic balls and the temperature of the plastic balls. The material of the plastic balls must be heated sufficiently to be able to fuse with neighboring balls. However, it must not be made too hot, so as to prevent the plastic balls from melting completely. Therefore, the degree of fusing and thus the size of the gaps can be controlled by a variation in the temperature.

A further parameter in adjusting the acoustical damping units is the speed of application. Thus, (single-layered or multi-layered) surfaces with defined characteristics of open and closed regions can be made possible by virtue of the size of the balls, the temperature of the plastic and the speed of application. That therefore permits an acoustical damping unit, in particular for electro-acoustical transducers, with a high degree of reproducibility.

Further embodiments of the invention are subject of the appendant claims.

Advantages and embodiments by way of example of the invention are described hereinafter with reference to the drawings.

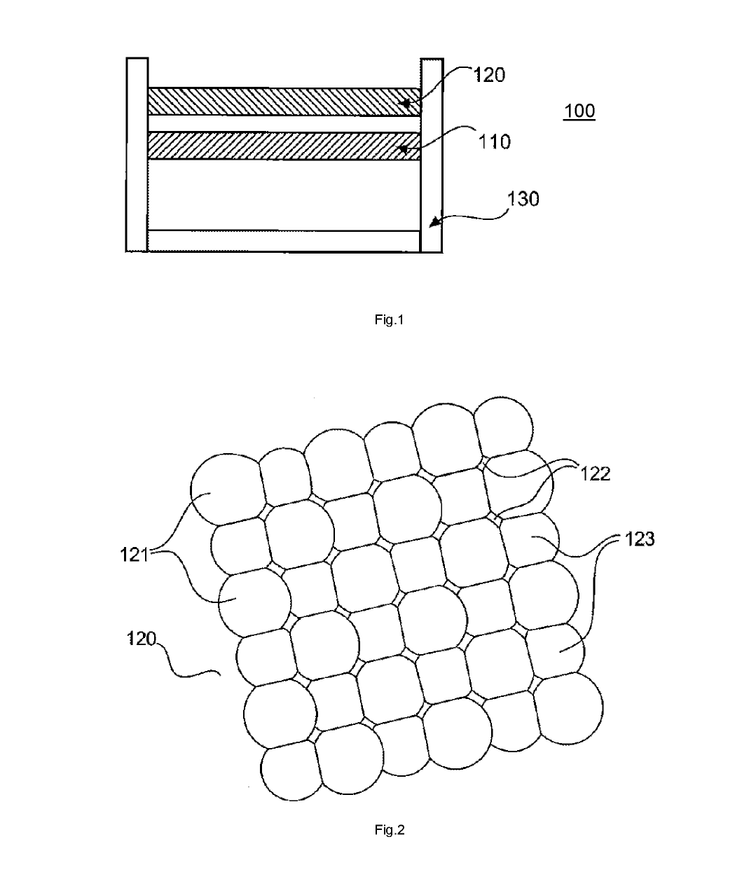

FIG. 1 shows a schematic view of an electro-acoustical transducer according to the invention,

FIGS. 2 through 4 each show a perspective view of a layer of an acoustical damping unit according to the invention,

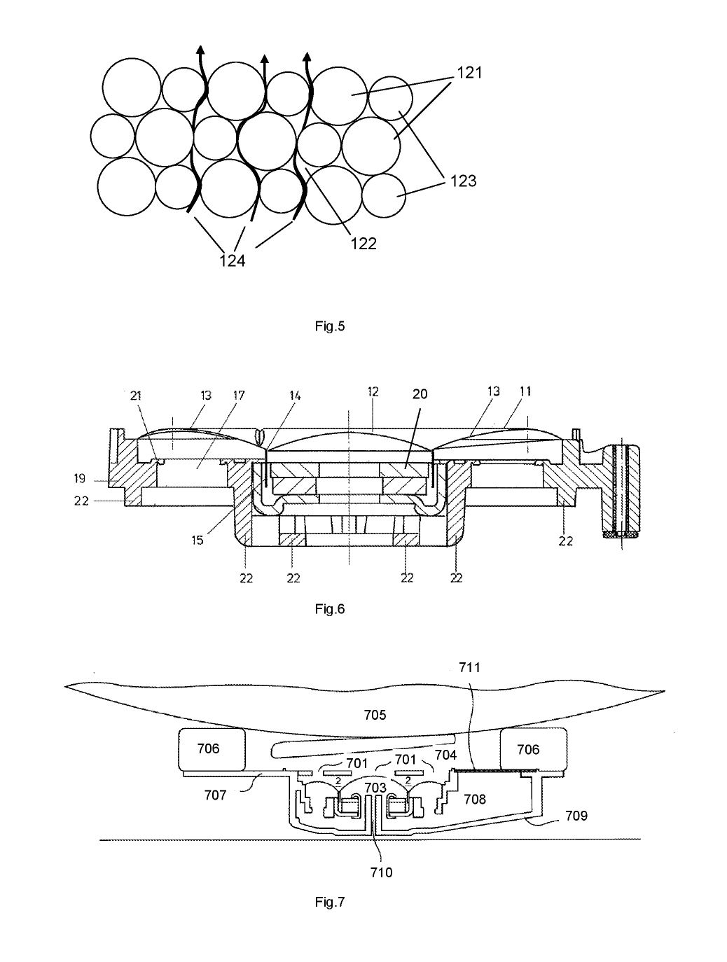

FIG. 5 shows air flowing through a damping element, and

FIGS. 6 through 9 show various electro-acoustical transducers with at least one damping unit according to the invention.

FIG. 1 shows a schematic view of an electro-acoustical transducer according to the invention. The electro-acoustical transducer 100 has a diaphragm system 110 and at least one acoustical damping unit 120. In FIG. 1, the diaphragm 110 and the damping unit 120 are in a chassis 130. The acoustical damping unit 120 can be located in front of the diaphragm system 110, as shown in FIG. 1. Alternatively, a damping unit can also be behind the diaphragm system 110.

FIG. 2 through 4 each show a perspective view of a layer of an acoustical damping unit according to the invention. As shown in FIG. 2 a layer of the acoustical damping unit 120 can have balls 121,123 of different sizes, which are arranged alternately in mutually juxtaposed relationship. Since the acoustical damping unit is a 3-dimensional arrangement, the balls of different sizes can be arranged alternately in mutually juxtaposed relationship in at least two dimensions per layer, or in all three dimensions in the case of plural layers. The balls 121,123 can touch each other, wherein gaps or openings 122 between the balls remain due to the curvature of the balls. It may also happen that some balls 121,123 do not touch all their neighboring balls, so that larger gaps or openings 122 remain. Air can flow through the gaps or openings 122. The gaps 122 are interconnected, so that air can flow though the complete acoustical damping unit 120.

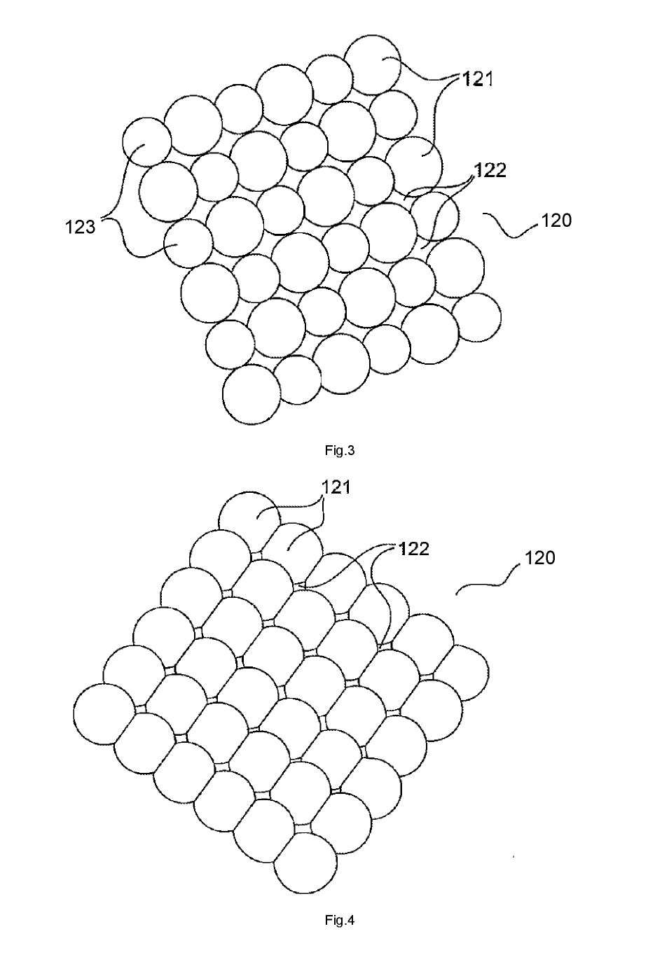

FIG. 3 shows a further layer of an acoustical damping unit 120. That layer also has two different kinds of balls 121,123 (in particular of different sizes). There are gaps or openings 122 between the balls. Here, gaps 122 as shown in FIG. 3 are larger than gaps 122 according to the embodiment of FIG. 2. The size of the gaps 122 can be influenced by the parameters of the 3D printing process. E.g. the gaps 122 will be smaller if the balls are warmer and thus fuse together to a greater degree. Likewise, the gaps 122 are smaller when using smaller balls than when using bigger balls.

FIG. 4 shows a layer of a damping unit 120 with a plurality of balls 121,which are all of substantially the same size. There are gaps or openings 122 respectively between the balls.

According to the invention, the size of the balls and the size of the gaps 122 can be controlled by the parameters of the 3D printing process.

According to the invention, an acoustical damping unit 120 can have a plurality of layers (as shown in FIGS. 2 through 4). Thus, there are not only gaps 122 between neighboring balls of a single layer, but also between balls or particles in stacked layers. Those gaps 122 are interconnected. To obtain this, the balls should not be overheated, since otherwise they will fuse together completely and then there are no interconnections between the individual gaps. Enclosed cavities, i.e. not interconnected, within the plastic are however not acoustically effective and do not change the damping characteristics of the plastic.

The acoustical characteristics of the acoustical damping unit 120 can be influenced by the size of the balls, the size of the gaps and the number of layers.

According to the invention the electro-acoustical damping units 120 are made in a 3D printing process, e.g. by using a 3D printer. In a 3D printing process 3-dimensional materials are built up in layers. The arrangement can be computer controlled, depending on predefined sizes and shapes based on CAD data. During the layer building process, physical or chemical hardening or melting processes may happen.

According to an aspect of the invention the interconnected gaps are not connected in straight lines, since the air flows around the bodies 121,123. FIG. 5 shows by way of example the path that the air flow 124 takes around the balls 121,123 through the gaps 122. It is to be noted that due to the 3-dimensional arrangement of the balls, the air flow 124 is not only in the plane of the drawing, but also (where balls touch each other) in front of and behind same.

According to the invention, plastic particles (e.g. balls or drops) can be made from thermoplastic materials by using an extruder nozzle. The bodies can then be positioned by the 3D printer according to CAD data in layers on an XY table of the 3D printer. Due to the temperature of the plastic balls leaving the extruder nozzle, they can fuse to neighboring balls at least at their edges. Thus, a connected mesh-like surface can result. If the XY table is shifted in the Z direction, then the next layer of plastic balls can be applied, which then again fuse to neighboring balls. In that way, a 3-dimensional acoustical damping unit 120 can be produced.

In producing such an acoustical damping unit, the size of the balls, the temperature of the plastic and the application speed can be varied. In that way, the porosity of the acoustical damping unit, i.e. the number and size of gaps 122 and therefore the acoustical characteristics, can be adjusted. Acoustical damping units of high reproducibility can be produced in that way.

According to the invention, acoustical damping units with exact damping characteristics can be produced in that way. The exact damping parameters can be obtained by variation in the size of the balls, the temperature of the plastic of the balls and the application speed. The acoustical damping units according to the invention do not have straight hole patterns, as would be the case with acoustical damping units obtained by lasers. With respect to the distortion factor values this is advantageous, in particular as compared to laser-produced acoustical damping units.

According to the invention 3-dimensional bodies with an integrated damping unit can be produced in one piece. For example, a damping element replacing a ring with silk or a chassis of an electro-acoustical transducer with integrated damping can be produced.

Since the electro-acoustical damping unit comprises a plurality of fused-together plastic balls, no problems occur with fibers that may spread annoyingly inside the machine or manufacturing area. Furthermore the acoustical damping units produced according to the invention have good mechanical stability and are thus easy to handle when producing an electro-acoustical transducer.

The damping unit according to the invention can be used at various locations, in particular as a part of or in the immediate proximity of electro-acoustical transducers. FIGS. 6 through 9 show various electro-acoustical transducers with at least one damping unit according to the invention.

FIG. 6 shows a cross-sectional view of a rotationally symmetric sound transducer 19 with a transducer basket 22 as a supporting element as well as a diaphragm system 11 comprising a central portion 12 and a bead 13. A 3-dimensional acoustical damping unit 17 is fitted in the form of a ring into a holder 21 below the bead 13. The diaphragm system 11 is driven by a coil 15 that is placed in a magnetic system 20 and fixed at the join 14 between the central portion 12 and the bead 13 on the diaphragm system 11. The acoustical damping unit 17 thus separates air volumes behind the diaphragm, in this case behind the bead 13, from the air in front thereof.

FIG. 7 shows a cross-sectional view of a headphone with a damping unit according to the invention. Here the damping unit as an acoustical resistor 711 separates a region 704 in front of the diaphragm 703 from a region 708 behind it. Sound will travel from the diaphragm 703 through openings 701 to the ear 705 of the user. The housing 707,709 that in this example is in two parts is disposed over a pad 706 in contact with the head 705 of a user. In this case it is particularly advantageous that by the choice of appropriate parameters a defined acoustical resistance can be imparted to the damping unit 711 according to the invention because the headphone sound characteristic can be influenced or adjusted in this way.

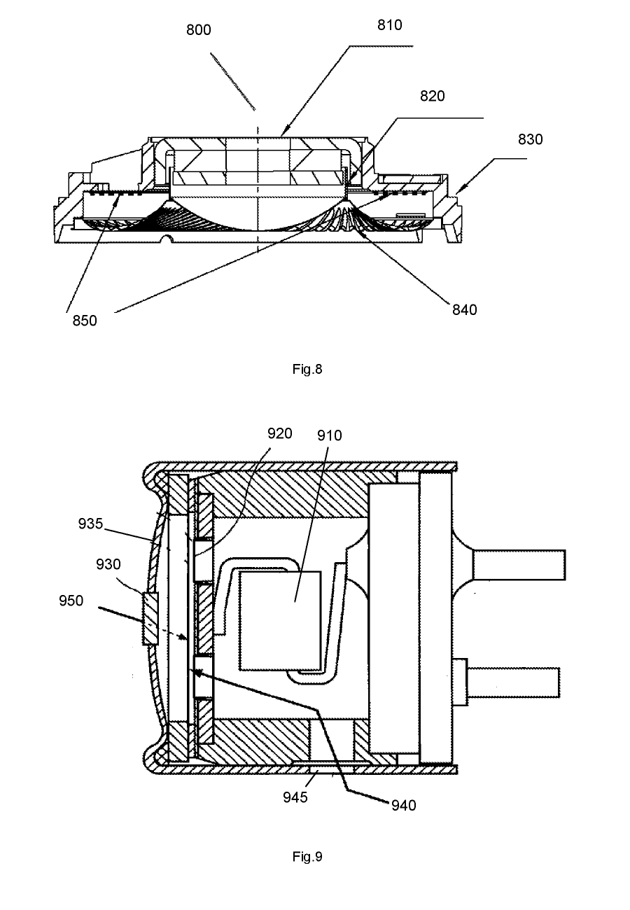

In FIG. 8 an electro-acoustical transducer 800, e.g. a headphone capsule, also using the electro-dynamic principle, has a magnet system 810 and a coil 820 that is fixed to a diaphragm 840. For damping the spring-mass system composed of the magnet system 810, the coil 820 and the diaphragm 840, the transducer also comprises at least one acoustical damping element 850 which is mounted on the chassis 830 and can be an acoustical damping element according to the present invention. The acoustical damping element 850 can also be made in several parts.

FIG. 9 shows a microphone with a capacitive sound transducer 910 connected to a diaphragm 920. In this case the actual sound signal 940 travels through a lateral sound entry 945 to the back of the diaphragm 920 while the front of the diaphragm is exposed to the delayed and damped sound signal 950. It is possible in that way to achieve a specific directional characteristic, in this case a cardioid directional characteristic. The delay and damping of the sound signal 950 is achieved by an acoustical damping element 930 according to the invention, that is inserted in a cap 935. It is particularly advantageous in that respect that the acoustical damping element 930, due to its structure and in particular due to its open-pored nature, has a defined acoustical resistance, since this influences the microphone's directional characteristic. Advantageously, because of the improved predictability or reproducibility respectively of the acoustical characteristics of the acoustical damping element 930 according to the invention, it is possible to achieve improved predictability or reproducibility of the microphone's directional characteristic.

Damping units according to the invention can advantageously be used in acoustical devices such as e.g. headphones, microphones or acoustical measuring instruments.

1. A method for producing an acoustical damping unit for an electro-acoustical transducer using a 3D printing process, comprising the steps of:
producing a plurality of bodies of predefined sizes, and
assembling the plurality of bodies in a desired shape by the 3D printing process,
wherein the bodies are arranged such that air can flow through gaps between the bodies, wherein the air can flow through the complete acoustical damping unit.

2. The method as set forth in claim 1 wherein the gaps between the bodies are interconnected and the air can flow through the interconnected gaps.

3. The method as set forth in claim 2 wherein the interconnected gaps are not interconnected in straight lines and the air flows around the bodies.

4. The method as set forth in claim 1 wherein the plurality of bodies comprises bodies of two different predefined sizes.

5. The method as set forth in claim 4 wherein the bodies of the two different sizes are arranged alternately in at least two dimensions by the 3D printing process.

6. The method as set forth in claim 1 wherein the bodies are plastic bodies, further comprising the steps:
applying the plastic bodies made of a thermoplastic material and produced by an extruder nozzle on an XY table, and
repeating the application of the plastic bodies until a desired 3-dimensional structure is obtained.

7. The method as set forth in claim 6 wherein by adjusting the size of the bodies, the temperature of the plastic and a speed of application of the plastic bodies a 3-dimensional structure with a desired acoustical damping characteristic is obtained.

8. An acoustical damping unit for an electro-acoustical transducer, comprising a plurality of interconnected plastic bodies, wherein the plastic bodies are produced and interconnected by a 3D printing process and each plastic body is at least partially fused or fixedly connected to neighboring plastic bodies, and wherein gaps remain between the plastic bodies and the gaps are interconnected such that air can flow through the acoustical damping unit.

9. The acoustical damping unit as set forth in claim 8 wherein the plastic bodies are made of a thermoplastic material.

10. The acoustical damping unit as set forth in claim 8 wherein the interconnected gaps are not interconnected in straight lines and the air can flow around the plastic bodies.

11. The acoustical damping unit as set forth in claim 8 wherein the plurality of plastic bodies comprises plastic bodies of two different predefined sizes.

12. The acoustical damping unit as set forth in claim 8 wherein the plastic bodies of two different sizes are arranged alternately in at least two dimensions by the 3D printing process.

13. An electro-acoustical transducer comprising at least one acoustical damping unit as set forth in claim 8.

14. A headphone comprising at least one acoustical damping unit as set forth in claim 8.

15. A microphone comprising at least one acoustical damping unit as set forth in claim 8.
